(19) United States
(12) Patent Application Publication
(10) Pub. No.: US 2026/0031638 A1
(43) Pub. Date: Jan. 29, 2026

(54) PORTABLE BATTERY CHARGER

(71) Applicant: MILWAUKEE ELECTRIC TOOL CORPORATION, Brookfield, WI (US)

(72) Inventors: Jeffrey L. Spenner, Germantown, WI (US); Bennett H. Speaks, Milwaukee, WI (US); Martin S. Huertas, New Berlin, WI (US)

(21) Appl. No.: 19/278,475

(22) Filed: Jul. 23, 2025

Related U.S. Application Data
(60) Provisional application No. 63/674,934, filed on Jul. 24, 2024.

(51) Int. Cl. H02J 7/00; H01M 10/615; H01M 10/637; H01M 10/643

(52) U.S. Cl. CPC H02J 7/0045; H01M 10/615; H01M 10/637; H01M 10/643; H02J 7/007194

(57) ABSTRACT

A portable battery charger includes a housing. The housing includes a battery receptacle configured to receive and connect to a battery. The charger also includes a heater surrounding the battery receptacle and a charging circuit provided in the housing to charge the battery. The charger further includes a temperature sensor disposed in the housing and an electronic processor in communication with the temperature sensor, the charging circuit, and the heater. The electronic processor is configured to determine, using the temperature sensor, a temperature of the battery, determine whether the temperature satisfies a low temperature threshold, in response to the temperature satisfying the low temperature threshold disable the charging circuit, and enable the heater to heat the battery.

### RELATED APPLICATIONS

This application claims priority to U.S. Provisional Patent Application No. 63/674,934, filed Jul. 24, 2024, the entire content of which is incorporated herein by reference.

### FIELD

The present disclosure relates to battery charging systems and, more particularly, to portable battery chargers.

### SUMMARY

Some batteries, e.g., batteries using a Lithium chemistry, may be unsafe to charge and discharge outside of a certain temperature range. Specifically, batteries may degrade quickly or become unsafe when charged at temperatures below the usable temperature range denoted by the manufacturer. Accordingly, there is a need for a battery charger than can safely charge batteries.

In one embodiment, a portable battery charger includes a housing having a battery receptacle configured to receive and connect to a battery. The charger also includes a heater surrounding the battery receptacle and a charging circuit provided in the housing to charge the battery. The charger further includes a temperature sensor disposed in the housing and an electronic processor in communication with the temperature sensor, the charging circuit, and the heater. The electronic processor is configured to determine, using the temperature sensor, a temperature of the battery and determine whether the temperature satisfies a low temperature threshold. The electronic processor is also configured to, in response to the temperature satisfying the low temperature threshold, disable the charging circuit and enable the heater to heat the battery.

The embodiments described herein are not limited in their application to the details of the configuration and arrangement of components set forth in the following description or illustrated in the accompanying drawings. The embodiments are capable of being practiced or of being carried out in various ways. Also, the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, a plurality of hardware and software-based devices, as well as a plurality of different structural components, may be utilized to implement the embodiments. For example, “servers” and “computing devices” described in the specification can include one or more processing units, one or more computer-readable medium modules, one or more input/output interfaces, and various connections (e.g., a system bus) connecting the components.

Other aspects of the disclosure will become apparent by consideration of the detailed description and accompanying drawings.

### BRIEF DESCRIPTION OF THE DRAWINGS

FIG. 1 is a perspective view of a portable battery charger according to some embodiments.

FIG. 2 is another perspective view of the portable battery charger shown in FIG. 1 illustrating a lid in an open configuration according to some embodiments.

FIG. 3. is a rear perspective view of the portable battery charger shown in FIG. 1 according to some embodiments.

FIG. 4 is a perspective view of a heater surrounding the battery receptacle of the portable charger shown in FIG. 1 according to some embodiments.

FIG. 5 is a perspective view of a portable battery charger according to some embodiments.

FIG. 6 is a bottom view of the portable charger shown in FIG. 5 according to some embodiments.

FIG. 7 is another perspective view of the portable charger shown in FIG. 5 with the lid open according to some embodiments.

FIG. 8 is a perspective view of a portable battery charger according to some embodiments.

FIG. 9 is a bottom view of the portable battery charger shown in FIG. 8 according to some embodiments.

FIG. 10 is a control diagram of any of the portable battery chargers shown in FIGS. 1-9 according to some embodiments.

FIG. 11 is a flow chart illustrating a process for any of the portable battery chargers shown in FIGS. 1-9 according to some embodiments.

### DETAILED DESCRIPTION

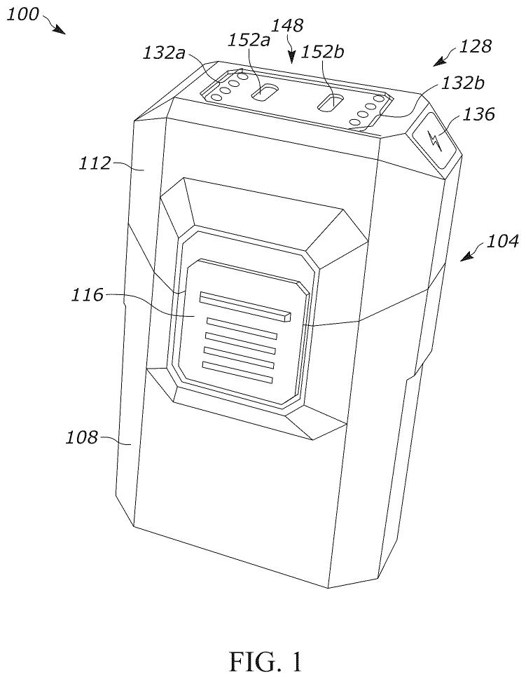

FIGS. 1-3 illustrate an example portable battery charger 100 (referred to hereafter as the charger 100) according to some embodiments. The charger 100 is used to charge one or more batteries 124 received in the charger 100. In some examples, the charger 100 may also be used to provide power to an attached device from the one or more batteries 124 received in the charger 100. In some embodiments, the charger 100 is portable and can accordingly be sized to fit within a user's hand. In other embodiments, the charger 100 may be larger, smaller, or have different dimensions based on use case. For example, the charger 100 may be shaped to fit within a person's clothes and may be planar-shaped.

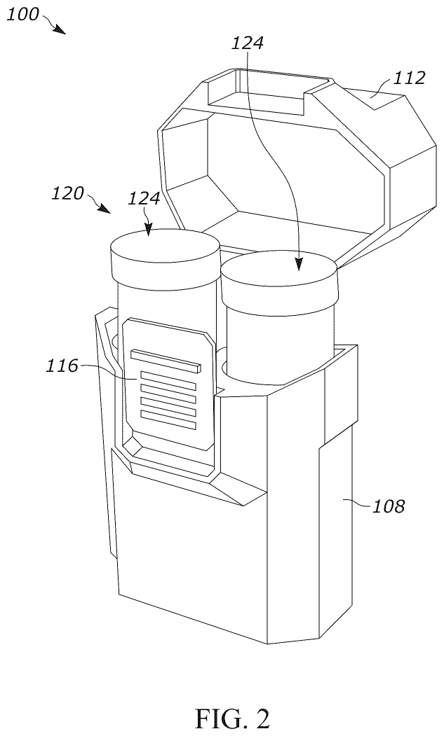

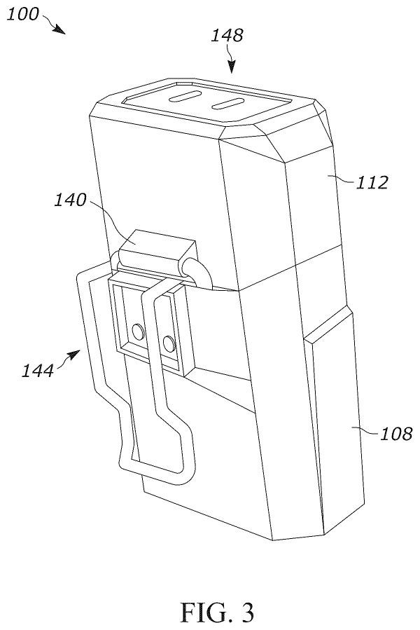

In the illustrated embodiment, the charger 100 includes a housing 104 that defines a body 108, a lid 112, and a latch 116. The lid 112 is pivotably attached to the body 108 about a hinge 140 (see FIG. 3) provided on a rear side of the body 108. The lid 112 can be pivoted between an open position (shown in FIG. 2) and a closed position (shown in FIGS. 1 and 3). The latch 116 is provided on a front side of the body 108 and is slidable or actuatable to engage with the lid 112, thereby fixing the lid 112 in the closed position. The body 108 and the lid 112 may include a seal to prevent ingress (e.g., water, cold air, etc.) into the housing 104. In one example, the lid 112 may be biased in an open position such that the lid 112 will automatically move to the open position when the lid 112 is not engaged by the latch 116. In other examples, the housing 104 may include a different configuration than that described herein. The components of the housing 104 including the body 108, the lid 112, and the latch 116 may be made of durable plastic material using, for example, an injection molding process, a 3-d printing, process, or the like. The body 108, the lid 112, and the latch 116 may be separately formed and joined together using, for example the hinge 140 and the like.

Referring to FIG. 2, the charger 100 is a two-bay charger that includes two battery receptacles 120a, 120b (herein referred to as battery receptacles 120) configured to receive two single cell rechargeable batteries 124. The battery receptacles 120 may extend through the body 108 and the lid 112. When the lid 112 is in the open position, the battery receptacles 120 are accessible such that the batteries 124 may be received and removed from the battery receptacles 120. When the lid 112 is in the closed position, the battery receptacles 120 are inaccessible and the batteries 124 are enclosed and secured within the housing 104. In other embodiments, the charger 100 may include more or fewer battery receptacles 120 that may be configured to receive more or fewer batteries 124. The batteries 124 include, for example, a lithium chemistry-based battery cell. Although the present disclosure is discussed with respect to lithium batteries, batteries with a different chemistry may be used.

Referring to FIG. 3, the charger 100 includes a belt hook 144 disposed on a rear-side of the body 108 adjacent to or below the hinge 140. The belt hook 144 is configured to attach to a belt, e.g., a tool belt. In some embodiments, the size and shape of the belt hook 144 may be adjusted to fit within other articles of clothing (e.g., pockets). Additionally, the position of the belt hook 144 may be adjustable and/or the belt hook 144 may be removable from the housing 104. In other embodiments, other types of attachment mechanism or couplings may be used such as magnets, clips, buttons, and the like.

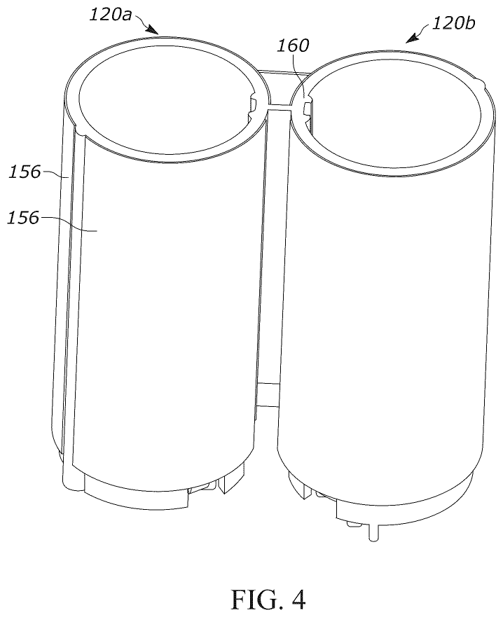

Referring to FIG. 4, a heater 156 surrounds the battery receptacles 120 and is configured to uniformly heat the batteries 124 received within the battery receptacles 120 to a chargeable temperature within 10 minutes at a negative twenty degree Celsius ambient temperature. The heater 156 is a low power heater configured to consume no more than 10 Watts of power. In the illustrated embodiment, the heater 156 surrounds each battery receptacle 120a, 120b (e.g., substantially entirely each battery receptacle 120a, 120b). In some embodiments the heater 156 may only surround portions of the battery receptacles 120a, 120b. The heater 156 may include multiple discrete sections or may be integrally formed as one uniform piece. Additionally, the heater 156 may include separate sections for each of the respective battery receptacles 120a, 120b, and each section may be separately activated. The heater 156 may incorporate heating elements to produce heat such as a resistive heating element, an inductive heating element, an infrared element etc. In some examples, the battery receptacles 120 may include a thermal interface between the heater 156 and the batteries 124. The thermal interface 160 may be a thermal conductor (e.g., copper), a thermal conductor and electric insulator (e.g., ceramic heat spreaders), or some combination thereof (e.g., a metal and plastic composite). In other embodiments, the heater 156 may directly contact the batteries 124. Additionally or alternatively, insulation or thermal shielding (e.g., heat reflective lining) may be included within the body 108 to surround the heater 156 and battery receptacles 120. The inclusion of a thermal interface and/or additional insulation surrounding the heater 156 allows for more heat output from the heater 156 to be transferred to the batteries 124 received within the battery receptacle 120.

Referring to FIG. 1, the charger 100 includes a user interface 128 and a power interface 148 disposed on the housing 104. The user interface 128 includes a plurality of indicators 132 configured to illuminate based on the charge of the received batteries 124. In the illustrated embodiment, the plurality of indicators 132 are split into two subsets of indicators 132a, 132b. Each subset of indicators 132a, 132b includes a portion of the plurality of indicators 132 corresponding to a respective battery receptacle 120a, 120b. Accordingly, the charge level (e.g., state of charge) of each individual battery 124 connected to the battery receptacle 120 may be displayed separately on the respective set of indicators 132. The user interface 128 also includes a power switch 136 operable by the user. In some embodiments, the power switch 136 is a pushbutton switch configured to control the operating mode of the charger e.g., enabling charging and disabling charging. The power interface 148 is configured to communicate power to and from the battery receptacles 120. The power interface 148 is used both to charge the batteries 124 disposed in the battery receptacles 120 and to draw power from the batteries 124 to charge a device coupled to the power interface 148. In the illustrated embodiment, the power interface 148 includes a bi-directional port 152a and an output port 152b. The power ports 152a, 152b are USB-C ports, and are accordingly configured to couple with USB-C compatible devices (e.g., a mobile phone). In other embodiments, other configurations may utilize more ports, have different port types (e.g., USB-A, AC, etc.), include discrete input and output ports, and output at a variety of voltages and wattages as understood in the art.

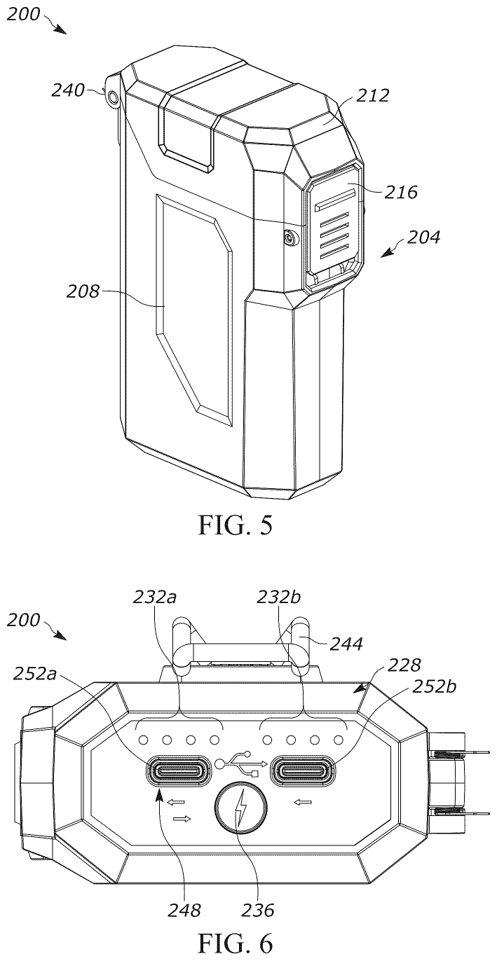

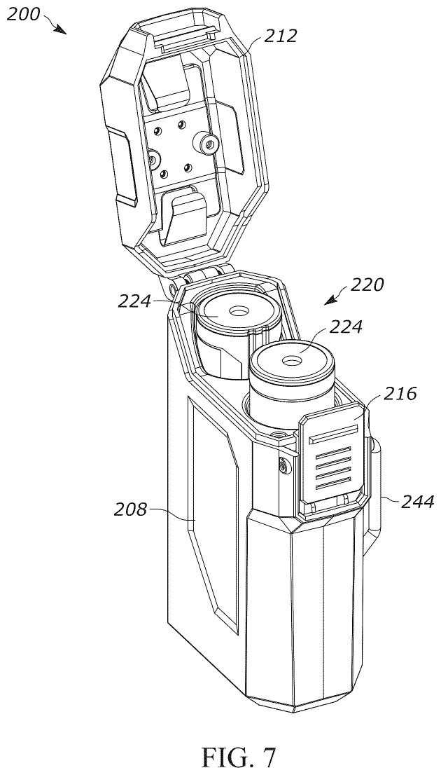

FIGS. 5-7 illustrate a portable battery charger 200 according to another example. The charger 200 is similar in some aspects to the charger 100 discussed above. The illustrated charger 200 includes a housing 204 defining a body 208 and a lid 212 pivotable relative to the body 208 about a hinge 240, a latch 216, a belt hook 244, and battery receptacles 220. In the example illustrated, the hinge 240 and the latch 216 are provided on opposing sides of the side surfaces of the housing 204. With reference to FIG. 7, the illustrated battery receptacles 220 may receive two single cell rechargeable batteries 224. Reference is hereby made to the description of the battery charger 100 shown in FIGS. 1-4 for description of features and elements of the charger 200 not specifically included below.

With reference to FIG. 6, the charger 200 includes a user interface 228 and a power interface 248 disposed on the body 208 opposite the lid 212. Similar to the charger 100, the illustrated charger 200 includes a plurality of indicators 232, a power switch 236, and a plurality of power ports 252a, 252b. The power port 252a is a bidirectional power port and the power port 252b is a unidirectional power port. In the illustrated embodiment, the user interface 228 and the power interface 248 are both disposed on a bottom surface of the body 208. In other embodiments, the user interface 228 may be separate from the power interface 248 and be disposed on different surfaces of the housing 204.

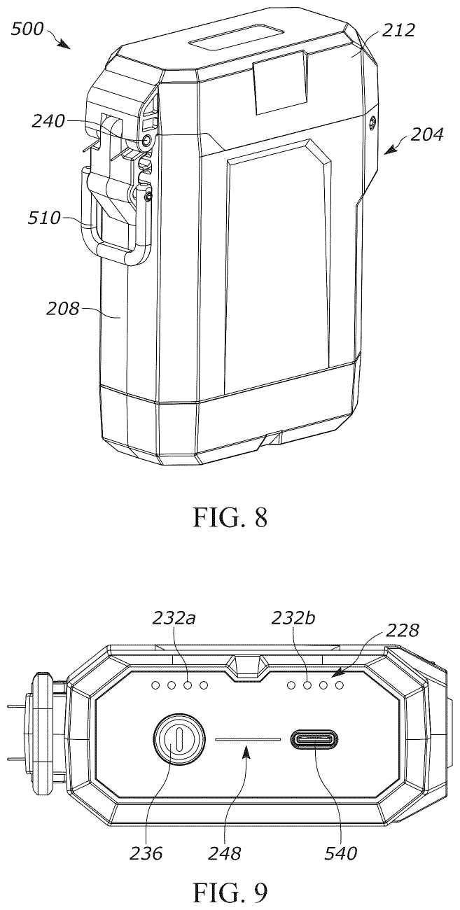

FIGS. 8 and 9 illustrate a portable battery charger 500 according to another example. The charger 500 is similar in some aspects to the charger 200 discussed above with like parts labeled with like numerals. The illustrated charger 500 includes a housing 204 defining a body 208 and a lid 212 pivotable relative to the body 208 about a hinge 240, and a belt hook 510. In the example illustrated, belt hook 510 is provided at a back of the housing under the hinge 240.

With reference to FIG. 9, the charger 500 includes a user interface 228 and a power interface 248 disposed on the body 208 opposite the lid 212. Similar to the charger 200, the illustrated charger 500 includes a plurality of indicators 232, a power switch 236, and one power port 540. The power port 540 is a bidirectional power port. In the illustrated embodiment, the user interface 228 and the power interface 248 are both disposed on a bottom surface of the body 208.

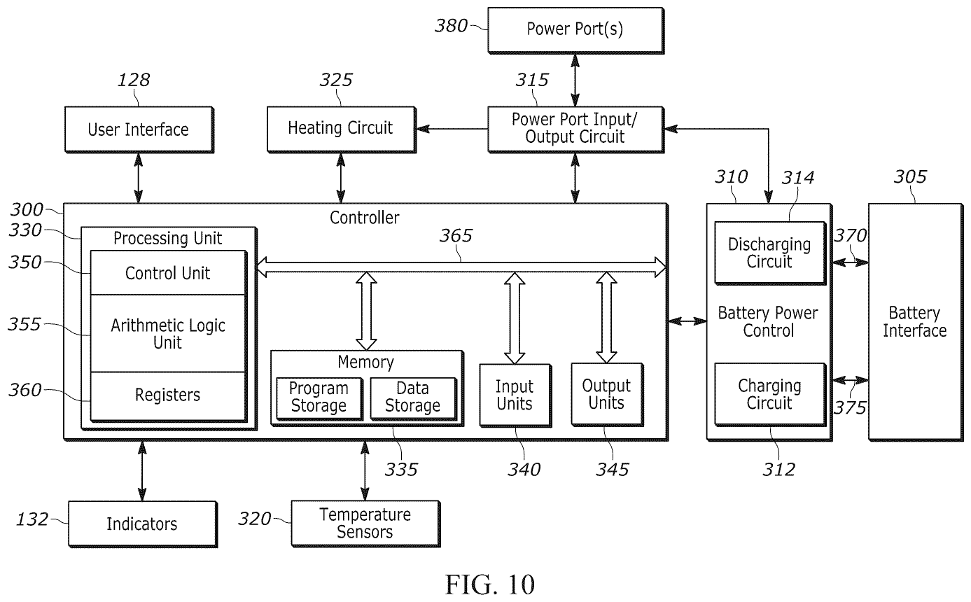

A controller 300 for the portable battery charger 100, 200, 500 is illustrated in FIG. 10. The controller 300 is configured to control the distribution of power to and from power ports 380 (e.g., power ports 152a, 152b, 252a, and 252b) to batteries 124, 224 connected to the battery interface 305. The controller 300 is electrically and/or communicatively connected to a variety of modules or components of the charger 100, 200, 500. For example, the illustrated controller 300 is connected to the battery interface(s) 305 (e.g., battery receptacle 120) through a battery power control module 310. The controller 300 can include or otherwise be in communication with the user interface 128 and indicators 132, a power input/output circuit 315, at least one temperature sensor 320, and a heating circuit 325. The controller 300 includes combinations of hardware and software that are operable to, among other things, control the operation of the battery charger 100, 200, 500 activate the indicators 132 (e.g., one or more LEDs), estimate the temperature of a connected battery 124 and ambient environment, and activate the heating circuit 325.

The controller 300 includes a plurality of electrical and electronic components that provide power, operational control, and protection to the components and modules within the controller 300 and/or battery charger 100, 200, 500. For example, the controller 300 includes, among other things, a processing unit 330 (e.g., an electronic processor, a microprocessor, a microcontroller, or another suitable programmable device), a memory 335, input units 340, and output units 345. The processing unit 330 includes, among other things, a control unit 350, an ALU 355, and a plurality of registers 360 and is implemented using a known computer architecture (e.g., a modified Harvard architecture, a von Neumann architecture, etc.). The processing unit 330, the memory 335, the input units 340, and the output units 345, as well as the various modules connected to the controller 300 are connected by one or more control and/or data buses (e.g., common bus 365). The control and/or data buses are shown generally in FIG. 10 for illustrative purposes.

The memory 335 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 330 is connected to the memory 335 and executes software instructions that are capable of being stored in a RAM of the memory 335 (e.g., during execution), a ROM of the memory 335 (e.g., on a generally permanent basis), or another non-transitory computer readable medium such as another memory or a disc. Software included in the implementation of the battery charger 100, 200, 500 can be stored in the memory 335 of the controller 300. The software includes, for example, firmware, one or more applications, program data, filters, rules, one or more program modules, and other executable instructions. The controller 300 is configured to retrieve from the memory 335 and execute, among other things, instructions related to the control processes and methods described herein. In other constructions, the controller 300 includes additional, fewer, or different components.

The battery interface(s) 305 includes a combination of mechanical components and electrical components configured to and operable for interfacing (e.g., mechanically, electrically, and communicatively connecting) the battery charger 100, 200, 500 with a battery 124, 224. For example, the battery interface(s) 305 is configured to transfer power between the power control module 310 via a power line 370 between the power control module 310 and the battery interface(s) 305. The battery interface(s) 305 is also configured to communicatively connect to the power control module 310 via a communications line 375.

The battery power control module 310 includes a charging circuit 312 and a discharging circuit 314. Accordingly, the battery power control module 310 is operable to control both the charging and discharging of the batteries 124, 224 connected via the battery interface 305. The charging circuit 312 receives power from the power port 380 and provides charging current to the battery interface 305 based on control signals from the controller 300. The charging circuit 312 may implement a constant voltage and/or a constant current charging to charge the batteries 124, 224. The battery power control module 310 receives power from the power port(s) 380 and/or sends power to the power port(s) 380 via the power input/output circuit 315. In some embodiments, the power port input/output circuit 315 and the battery power control module 310 may charge a received battery 124, 224 and output power through a power port 380 at the same time. That is, the power port input/output circuit 315 and the battery power control module 310 may enable pass-through power. In some embodiments, more than one power port 380 may be electrically and communicatively connected to the battery power control module 310 through the power port input/output circuit 315.

The power port input/output circuit 315 controls the direction and allocation of power from the power port(s) 380 to the battery power control module 310 and the heating circuit 325. The power port input/output circuit 315 may also control power from the battery power control module 310 to a specific power port 380. For example, in embodiments with multiple power ports, one power port 380 may be used as an input by the power port input/output circuit 315 and thereby provide power to the battery power control module 310 to charge a battery 124, 224. Another power port 380 may be used as an output by the power port input/output circuit 315 and may draw power from another battery 124, 224 through the battery power control module 310 and power port input/output circuit 315. In another example, a power port 380 may be limited to an output-only mode and the power port input/output circuit 315 will disconnect the output-only power port 380 from any circuitry using a power input to power the heating circuit 325 and/or to charge a connected battery 124, 224. In some embodiments, the heating circuit 325 may be entirely disconnected from the battery interface 305 and battery power control module 310. That is, the heating circuit 325 may only be powered through power input through the power port 380. Consequently, the heating circuit 325 may not operate when the power port 380 cannot provide sufficient power. Additionally, in such an embodiment, the power port input/output circuit 315 may alternate or divide a power input from the power port 380 between the heating circuit 325 and the battery power control module 310. In other embodiments, the heating circuit 325 may draw power from the battery 124, 224.

The temperature sensors 320 may include one or more temperature sensors located throughout the charger 100, 200, 500. The temperature sensors 320 may be any temperature sensor known in the art including, for example, thermistors, infrared sensors, thermocouples, positive thermal coefficient (PTC) elements, negative thermal coefficient (NTC) elements, and the like. The temperature sensors 320 are configured to determine the temperature of a received battery 124, 224. In some embodiments, the thermal relationships or gradients between the temperature measured by the temperature sensors 320 and other components of the battery charger 100, 200, 500 can be stored in the memory 335 of the controller 300.

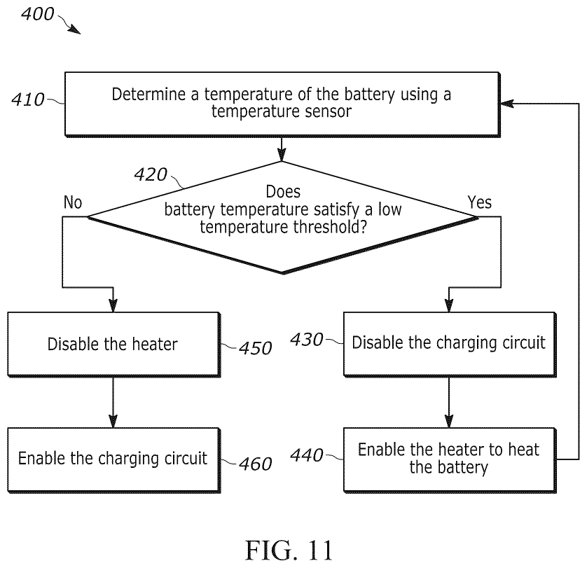

FIG. 11 illustrates a flowchart for an example method 400 for charger 100 operation. The method 400 may be implemented by the controller 300 to activate the heater 156 and the charging/discharging circuits disposed in the battery power control module 310. At step 410, the controller 300 determines, using the temperature sensor 320, a temperature of a battery 124. In some examples, the controller 300 may constantly monitor the temperature. In other examples, the controller 300 may monitor the temperature before beginning charging/discharging. In some embodiments, the temperature sensor 320 may directly measure the temperature of a battery 124, 224. In some embodiments, the temperature sensor 320 may measure a section of the charger other than the battery 124, 224 (e.g., the heater 156) and the controller 300 may extrapolate the temperature of the battery 124, 224 received in the battery receptacle 120 based on the temperature measurement of the temperature sensor 320. In some embodiments, temperature sensors 320 may be disposed adjacent to the battery 124, 224, the heater 156, and/or another component to determine the specific temperature of the corresponding component. Other temperature sensors 320 may also be disposed adjacent to the external surface of the charger 100, 200, 500 to determine the ambient temperature. In yet other embodiments, multiple temperature sensors 320 may be disposed the in same component (e.g., battery receptacle 120, 220) to improve the accuracy of a reading instead of relying on the reading at one location. The controller may also communicate with the battery power control module 310 to detect if a battery is connected to the battery interface 305 and may additionally determine the number of batteries connected to the battery interface 305.

At step 420, the controller 300 determines whether the battery temperature satisfies a low temperature threshold. For example, the battery temperature satisfies the low temperature threshold when the battery temperature is less than or equal to zero degrees Celsius. To determine whether the battery temperature meets the low temperature threshold, the controller 300 compares the measured or extrapolated temperature value of the battery to an internal temperature threshold stored in memory 335. In some embodiments, the controller 300 may also determine if the battery temperature is below a predetermined maximum temperature or within a predetermined temperature relative to the ambient environment. For example, the controller 300 may return a fault if the temperature within the charger 100, 200, 500 is greater than fifty degrees Celsius or if measured temperature at the exterior of the charger 100, 200, 500 is greater than thirty degrees Celsius over the ambient temperature. Upon determining a fault, the controller 300 may disable power transfer to and from the power ports 380 and indicate an error (e.g., via the user interface 128, 228).

In response to determining that the battery temperature satisfies the low temperature threshold, at step 430, the controller 300 disables the charging circuit 312. In some embodiments, the controller 300 may also disable the discharging circuit 314. Accordingly, the controller 300 may communicate with the battery power control module 310 to disable both the charging circuit 312 and discharging circuit 314 to ensure no power is sent to the battery 124, 224 through the battery interface 305. In some embodiments, only one of the charging circuit 312 or the discharging circuit 314 within the battery power control module 310 may be disabled. For example, the controller 300 may only disable the charging circuit 312 and enable the discharging circuit 314 to output power below the low temperature threshold (e.g., zero degrees Celsius). Conversely, the controller may disable the discharging circuit 314 at a temperature above the low temperature threshold. In short, the temperatures at which charging and discharging are permitted may be different from one another. Additionally or alternatively, the controller 300 may communicate with the power port input/output circuit 315 to disable the power transfer (e.g., using a FET) to the battery power control module 310. In other embodiments, the battery power control module 310 may limit the output of the battery to the controller to maintain operation and to control the indicators 132.

At step 440, the controller 300 enables the heater 156 to heat the battery 124, 224. The controller 300 may enable the heater 156 in response to the temperature satisfying the low temperature threshold. The controller 300 controls the power port input/output circuit 315 to provide power flow from the power ports 380 to the heating circuit 325, thereby allowing the heater 156 to heat the battery 124. The heating circuit 325 heats the heater 156. In some embodiments, the controller 300 may indicate an error using the indicators 132 to convey that insufficient power is being provided to the heating circuit 325. After activating the heater at step 440, the method 400 returns to step 410 and continues to monitor the battery temperature.

At step 450, upon determining that the battery temperature does not meet the low temperature threshold, the controller 300 disables the heater 156. In some embodiments, the controller 300 may enable battery power transfer without disabling the heater up to a certain temperature. For example, the controller 300 may include a delay or other parameter to enable the heating circuit 325 for a particular time period or temperature range (e.g., up to ten degrees C.) such that the heater 156 continues to heat the battery 124 at temperatures above the low temperature threshold. At step 460, the controller 300 enables the charging circuit 312. The controller 300 enables the charging circuit 312 to charge the batteries 124, 224.

Various features and advantages are set forth in the following claims.

1. A portable battery charger comprising:
a housing;
a battery receptacle provided in the housing and configured to receive and connect to a battery;
a heater surrounding the battery receptacle;
a charging circuit provided in the housing to charge the battery;
a temperature sensor disposed in the housing; and
an electronic processor electrically connected to the temperature sensor, the charging circuit, and the heater, the electronic processor configured to:
determine, using the temperature sensor, a temperature of the battery, and
in response to the temperature satisfying a low temperature threshold,
disable the charging circuit; and
enable the heater to heat the battery.

2. The portable battery charger of claim 1, wherein the housing defines a body including the battery receptacle and a lid pivotable relative to the body between a closed position, where the battery receptacle is enclosed, and an open position, where the battery receptacle is accessible.

3. The portable battery charger of claim 2, wherein the heater is provided between the housing and the battery receptacle.

4. The portable battery charger of claim 1, further comprising a bi-directional power port disposed on the housing, the bi-directional power port configured to provide power to the charging circuit and the heater.

5. The portable battery charger of claim 1, wherein the electronic processor determines that the temperature satisfies the low temperature threshold when the temperature of the battery is less than zero degrees Celsius.

6. The portable battery charger of claim 1, wherein the electronic processor is further configured to: in response to the temperature not satisfying the low temperature threshold, enable the charging circuit.

7. The portable battery charger of claim 6, wherein the electronic processor is further configured to: in response to the temperature not satisfying the low temperature threshold, disable the heater.

8. A portable battery device comprising:
a housing;
a battery receptacle provided in the housing and configured to receive and connect to a battery;
a heater substantially surrounding the battery receptacle to heat the battery;
a temperature sensor disposed in the housing; and
an electronic processor electrically connected to the temperature sensor and the heater, the electronic processor configured to:
determine, using the temperature sensor, a temperature of the battery, and
in response to the temperature satisfying a low temperature threshold enable the heater to heat the battery.

9. The portable battery device of claim 8, wherein the housing defines a body including the battery receptacle and a lid pivotable relative to the body between a closed position, where the battery receptacle is enclosed, and an open position, where the battery receptacle is accessible.

10. The portable battery device of claim 9, wherein the heater is provided between the housing and the battery receptacle.

11. The portable battery device of claim 8, further comprising a power port disposed on the housing, the power port configured to provide power to the heater.

12. The portable battery device of claim 8, wherein the electronic processor determines that the temperature satisfies the low temperature threshold when the temperature of the battery is less than zero degrees Celsius.

13. The portable battery device of claim 8, wherein the electronic processor is further configured to: in response to the temperature not satisfying the low temperature threshold, disable the heater.

14. A portable battery charger comprising:
a housing;
a battery receptacle provided in the housing and configured to receive and connect to a battery;
a heater configured to heat the battery receptacle;
a charging circuit provided in the housing to charge the battery;
a temperature sensor disposed in the housing; and
an electronic processor electrically connected to the temperature sensor, the charging circuit, and the heater, the electronic processor configured to:
determine, using the temperature sensor, a temperature of the battery, and
in response to the temperature satisfying a low temperature threshold,
disable the charging circuit; and
enable the heater to heat the battery.

15. The portable battery charger of claim 14, wherein the housing defines a body including the battery receptacle and a lid pivotable relative to the body between a closed position, where the battery receptacle is enclosed, and an open position, where the battery receptacle is accessible.

16. The portable battery charger of claim 15, wherein the heater is provided between the body and the battery receptacle.

17. The portable battery charger of claim 14, further comprising a power port disposed on the housing, the power port configured to provide power to at least one of the charging circuit and the heater.

18. The portable battery charger of claim 14, wherein the electronic processor determines that the temperature satisfies the low temperature threshold when the temperature of the battery is less than zero degrees Celsius.

19. The portable battery charger of claim 14, wherein the electronic processor is further configured to: in response to the temperature not satisfying the low temperature threshold, enable the charging circuit.

20. The portable battery charger of claim 19, wherein the electronic processor is further configured to in response to the temperature not satisfying the low temperature threshold, disable the heater.
